(19) United States
(12) Patent Application Publication
(10) Pub. No.: US 2005/0268124 A1
(43) Pub. Date: Dec. 1, 2005

(54) Apparatus and method for voltage switching

(75) Inventors: Tien Pham, Houston, TX (US); Charles Walker, Houston, TX (US); Allen Shorter, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/095,858

(22) Filed: Mar. 31, 2005

Related U.S. Application Data
(60) Provisional application No. 60/574,456, filed on May 25, 2004.

(51) Int. Cl. G06F 1/26

(52) U.S. Cl. 713/300

(57) ABSTRACT

A voltage switching apparatus and method are disclosed. At least one disclosed method includes providing, when a mode selection signal is in a first state, a first power rail voltage on a first power voltage line and a second, different power rail voltage on a second power voltage line. After the mode selection signal transitions to a second state, a second power rail voltage is provided on the first power voltage line and a switch between the first and second power voltage lines is closed.

### CROSS-REFERENCE TO A RELATED APPLICATION

The present application claims the benefit of, and incorporates by reference, provisional application Ser. No. 60/574,456, filed May 25, 2004, and entitled “Apparatus And Method For Voltage Switching.”

### BACKGROUND

Personal computer systems typically include a peripheral component interconnect bus, which is more commonly known as a PCI bus. Industry standards for the PCI bus and closely related bus technologies are defined by a special interest group, PCI-SIG®. PCI-SIG has defined industry standards for PCI Conventional, PCI Express, and PCI-X technologies. These different standards reflect an evolution of the PCI standard in response to a need for increased bus bandwidth. In designing the newer standards, PCI-SIG provided for backward compatibility with the older standards.

Computers with PCI-compliant buses employ slot connectors having a number of conductive spring-loaded contacts. When a PCI-compliant circuit board is inserted into the slot connector, the spring-loaded contacts make contact with conductive traces near one edge of the circuit board. The slot connectors have only a fixed number of contacts, and hence the standard provides for only a fixed number of bus signal lines. As new PCI-related standards are defined, the functions of some of these bus signal lines are redefined.

To provide for backward compatibility, computers may employ a bus that operates in different modes. For example, the PCI-X standard provides that more recent PCI-X buses should operate in at least two different modes. Mode 1 provides backward compatibility with legacy PCI-X devices, while mode 2 provides enhanced bus performance. In mode 1, the power signal for the bus is 3.3 volts, while in mode 2 the power signal is 1.5 volts. A bus controller identifies the appropriate mode for the devices in each slot, and employs some switching mechanism to supply the appropriate power to the power signal line(s). The switching mechanism must satisfy fairly various electrical requirements in the PCI-X standard. Improvements relating to such switching mechanisms are desirable.

### BRIEF DESCRIPTION OF THE DRAWINGS

The following detailed description can be better understood with reference to the following figures:

FIG. 1 is a block diagram of a computer system including a PCI-X bus bridge and a PCI-X bus, according to various embodiments of the present invention;

FIG. 2 is a block diagram of a PCI-X bus bridge connected to a PCI-X bus having multiple PCI slots, according to various embodiments of the present invention;

FIG. 3 is a block diagram of a switching circuit, according to one embodiment of the present invention; and

FIG. 4 is a block diagram of another switching circuit, according to one embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the appended claims.

### NOTATION AND NOMENCLATURE

Certain terms are used throughout the following description and claims to refer to particular system components and configurations. As one skilled in the art will appreciate, companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .”

The term “couple” or “couples” is intended to mean either an indirect or a direct electrical connection. Thus, if a first device couples to a second device, that connection may be through a direct electrical connection, or through an indirect electrical connection via other devices and connections.

The term “power rail” is intended to mean a conductor carrying a direct-current (DC) voltage from a power source.

The components within the drawings are not necessarily to scale relative to each other, emphasis instead being placed upon clearly illustrating the disclosed principles. Matching reference numerals indicate corresponding components throughout the various figures.

### DETAILED DESCRIPTION

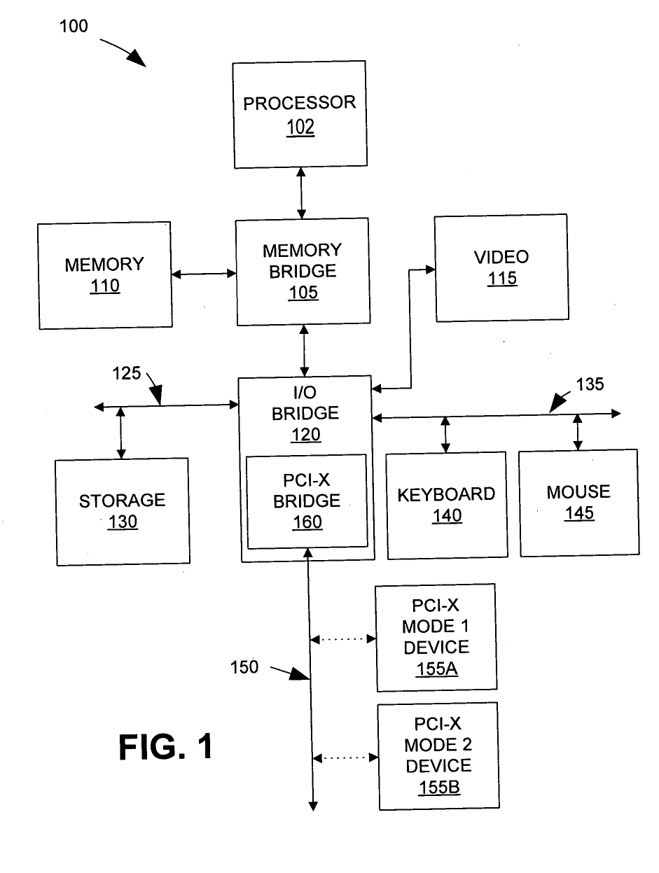

FIG. 1 shows a block diagram of an illustrative computer system 100 having (among other things) a processor 102, a memory bridge 105, a system memory 110, a video controller 115, and an I/O bridge 120. The memory bridge 105 couples the processor 102 to system memory 110 and to the I/O bridge 120. The video controller 115 may be coupled to the processor 102 via the memory bridge 105, or via the I/O bridge 120. The processor 102 executes software instructions stored in memory 110 to retrieve data from any of various I/O devices, to process the data, and to produce results that typically are displayed on a monitor (not shown) coupled to video controller 115. The processor 102 may alternatively or additionally provide computational results to various I/O devices.

The I/O bridge 120 couples the processor 102 and memory 110 (via memory bridge 105) to one or more peripheral buses. Examples of peripheral buses include a small computer system interface (“SCSI”) bus 125, a low pin count (“LPC”) bus 135, and a PCI-X bus 150. The various I/O devices couple to one of the peripheral buses to communicate with the rest of the computer system 100. In FIG. 1, for example, a nonvolatile storage device 130 (such as a magnetic or optical disk) couples to the SCSI bus 125. A keyboard 140 and a mouse 145 couple to the LPC bus 135. Socket connectors for other peripherals 155A, 155B (such as a sound card, a network interface, a modem, an external information storage device, or a data acquisition card) couple to the PCI-X bus 150. I/O bridge 120 includes a PCI-X bus bridge 160 that supports communications with any PCI-X devices that may be inserted in the socket connectors.

In at least some embodiments, the PCI-X bus bridge 160 may support PCI-X mode 1 and PCI-X mode 2 devices. As is described below in more detail, the PCI-X bus bridge 160 is configured to receive a mode selection signal that results from the influence of each attached PCI-X device 155A, 155B. Each device may ground or isolate the mode selection signal line in accordance with a desired operating mode for that device. The PCI-X bus bridge may determine the operating mode for the PCI-X bus 150 in response to the resulting mode selection signal.

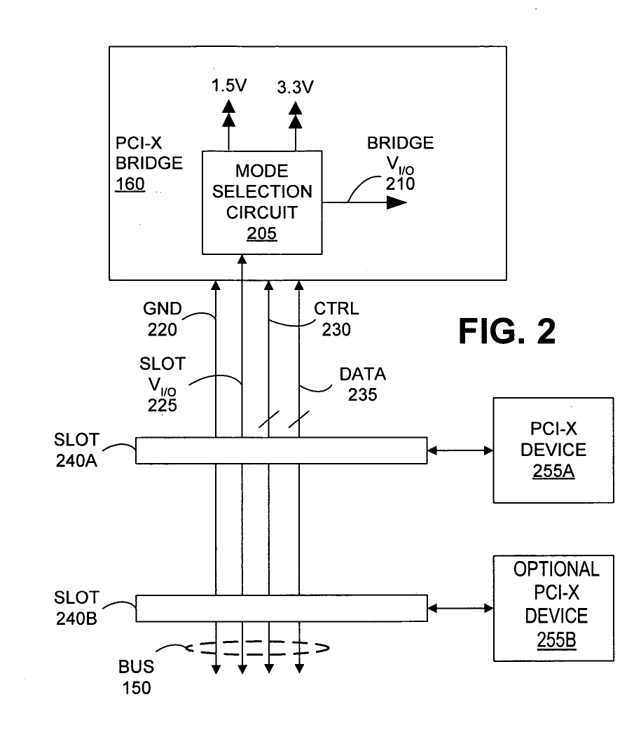

FIG. 2 shows a block diagram of the PCI-X bus bridge 160 connected to a PCI-X bus 150 having PCI slots 240A, 240B. The PCI-X bus bridge 160 includes a mode selection circuit 205 coupled to a 1.5 volt power rail and a 3.3 volt power rail. The mode selection circuit 205 sources a power voltage (“Bridge V_{I/O}”) for the PCI-X bus bridge control circuitry and a power voltage (“Slot V_{I/O}”) for devices inserted in the PCI slots. This configuration allows tight control of variations between these power voltages.

Power voltages Bridge V_{I/O} and Slot V_{I/O} are provided on power lines 210 and 225, respectively. FIG. 2 shows various elements of PCI-X bus 150, including a ground line 220, Slot V_{I/O} power line 225 (noted above), a set of control lines 230, and a set of data lines 235. Other signal lines may be included as well. FIG. 2 further shows the various signal lines connected to PCI slots 240A and 240B, which in turn are respectively coupled to removable PCI-X devices 255A and 255B. In one particular embodiment, slot 240A may support both PCI-X mode 1 and mode 2, while slot 240B may be limited to PCI-X mode 1.

The PCI-X devices in the above-described embodiments may be PCI cards that fit a PCI socket. PCI sockets hold such cards by frictional contact, allowing the cards to be easily removed. In alternative embodiments, the PCI-X devices may be integrated onto a circuit board with the PCI-X bus bridge 160 and other computer components.

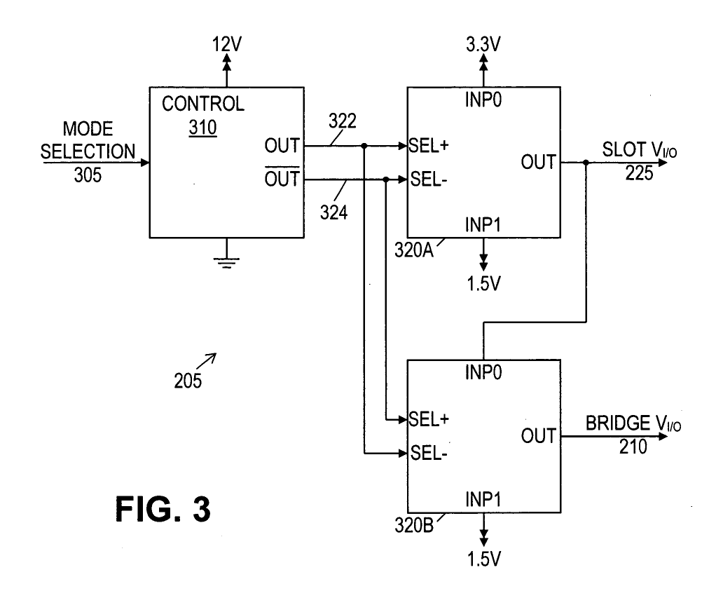

FIG. 3 shows a block diagram of the switching circuit 205 according to one embodiment of the present invention. Switching circuit 205 includes a control circuit 310 coupled to two selector circuits 320A, 320B by a pair of control signals 322 and 324. A mode selection signal is generated by the operation of removable PCI-X devices on bus 150 (e.g., by each device's grounding or high-impedance connection of a bus signal line in accordance with their desired bus operating mode). The control circuit 310 receives a mode selection signal 305 and converts it into two control signals 322, 324. In the embodiment of FIG. 3, the mode selection signal is 0 and 3.3 volts for logical low and logical high, respectively. The control signals 322, 324 are 0 and 12 volts for logical low and logical high, respectively. Control signal 322 may be logically low when the mode selection signal 305 is low, and may be logically high when the mode selection signal is high. Loosely speaking, the control signal 324 is the logical inverse of control signal 322, although in one embodiment positive-going edges of control signal 322 are slightly delayed relative to negative-going edges of control signal 324. The control circuit 310 uses both control signals 322, 324 to control each of the two selector circuits 320A, 320B.

The selector circuits 320A, 320B each have four input lines (SEL+, SEL−, INP0, INP1) and one output line (OUT). Each selector circuit electrically couples the INP0 signal line to the OUT signal line when the SEL+ control line is logically high. Similarly, each selector circuit electrically couples the INP1 signal line to the OUT signal line when the SEL− control line is high. The electrical connections may be provided via a transistor, a relay, or some other form of electrical switch internal to the selector circuit.

Selector circuit 320A may be configured as follows. The SEL+ control line receives control signal 322, the SEL− control line receives control signal 324, the INP0 signal line is coupled to a 3.3V power rail, the INP1 signal line is coupled to a 1.5V power rail, and the OUT signal line is coupled to the Slot V_{I/O} power line 225. In response to the various control and input signals, selector circuit 320A provides the Slot V_{I/O} power voltage on line 225.

Selector circuit 320B may be configured as follows. The SEL+ control line receives control signal 324, the SEL− control line receives control signal 322, the INP0 signal line is coupled to Slot V_{I/O} power voltage line 225, the INP1 signal line is coupled to a 1.5V power rail, and the OUT signal line is coupled to the Bridge V_{I/O} power voltage line 210. In response to the various control and input signals, selector circuit 320B provides the Bridge V_{I/O} power voltage on line 210.

The operation of switching circuit 205 is as follows. A low mode selection signal 305 causes control circuit 310 to force control signal 322 low and to force control signal 324 high. This assertion of control signal 324 causes selector circuit 320A to electrically couple the Slot V_{I/O} power voltage line 225 to the 1.5V power rail, and causes selector circuit 320B to electrically couple the Bridge VI/O power voltage line 210 to the Slot V_{I/O} power voltage line 225. This configuration is suitable for PCI-X mode 2 operation of bus 150. A transition of the mode selection signal 305 from low to high causes control circuit 310 to force control signal 324 to transition from high to low. In one embodiment, control signals 322 and 324 are both momentarily low before control signal 322 transitions from low to high. While both control signals are low, both selector circuits electrically isolate their OUT signal lines from both of the input signal lines. After control signal 322 transitions to a logical high, selector circuit 320A electrically connects the Slot V_{I/O} power voltage line 225 to the 3.3V power rail, and selector circuit 320B electrically connects the Bridge VI/O power voltage line 210 to the 1.5V power rail. This configuration is suitable for PCI-X mode 1 operation of bus 150.

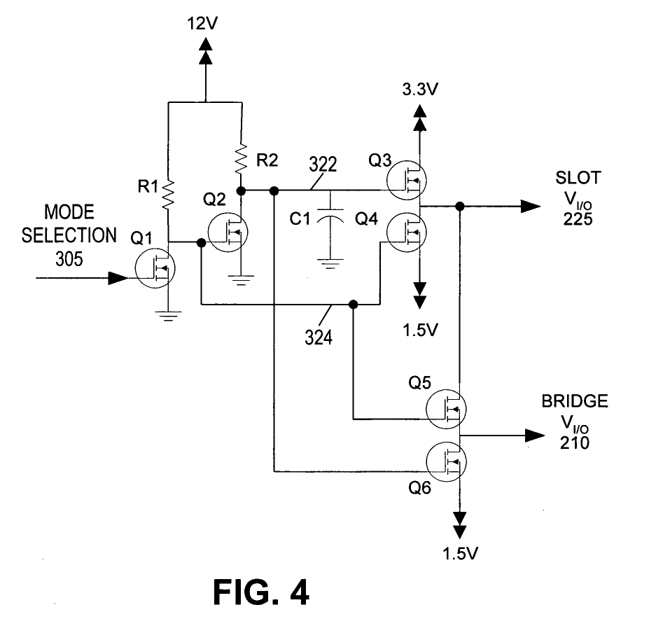

FIG. 4 shows an illustrative implementation of switching circuit 205. The illustrative implementation employs a 0.1 μF capacitor C1, two 1 kΩ resistors R1, R2, and six n-channel MOSFETs Q1-Q6. Capacitor C1, resistors R1 and R2, and transistors Q1 and Q2 form one implementation of control circuit 310. Transistors Q3 and Q4 form one implementation of selector circuit 320A, and transistors Q5 and 06 form an implementation of selector circuit 320B.

Transistor Q1 has a gate coupled to the mode selection signal line 305, a drain coupled to a 12V power rail via resistor R1, and a source coupled to ground. The control signal line 324 is coupled between the drain of transistor Q1 and the gates of transistors Q2, Q4, and Q5. Transistor Q2 has a drain coupled to the 12V power rail via resistor R2, and a source coupled to ground. The control signal line 322 is coupled from the drain of transistor Q2 to the gates of transistors Q3 and Q6. Capacitor C1 is coupled between ground and control signal line 322. Transistor Q3 has a drain coupled to a 3.3V power rail, and a source coupled to Slot V_{I/O} power voltage line 225. Transistor Q4 has a drain coupled to Slot V_{I/O} power voltage line 225, and a source coupled to a 1.5V power rail. Transistor Q5 has a drain coupled to the Slot V_{I/O} power voltage line 225, and a source coupled to the Bridge V_{I/O} power voltage line 210. Transistor Q6 has a source coupled to the Bridge V_{I/O} power voltage line 210, and a source coupled to the 1.5V power rail.

The operation of the FIG. 4 implementation is as follows. When mode selection signal 305 is low (about 0V), transistor Q1 is OFF. When transistor Q1 is OFF, resistor R1 pulls control signal 324 high (about 12V), causing transistors Q2, Q4, and Q5 to turn ON. Transistor Q2 pulls control signal line 322 low (about 0V), causing transistors Q3 and Q6 to turn OFF. Transistor Q4 couples the Slot V_{I/O} power voltage line 225 to the 1.5V power rail, and transistor Q5 couples the Bridge V_{I/O} power voltage line 210 to the Slot V_{I/O} power voltage line 225. This configuration is suitable for PCI-X mode 2 operation of bus 150.

When mode selection signal 305 transitions from low to high (about 3.3V), transistor Q1 turns ON, pulling control signal line 324 to go low (about 0V) and causing transistors Q2, Q4, and Q5 to turn OFF. Then transistor Q2 is OFF, capacitor C1 begins charging via resistor R2, bringing control signal line 322 high (about 12 V) after a few tenths of a millisecond. While both control signal lines 322 and 324 are low, transistors Q3-Q6 are OFF, causing both the Slot V_{I/O} power voltage line 225 and the Bridge V_{I/O} power voltage line 210 to be isolated from the voltage rails. As control signal line 322 goes high, transistors Q3 and Q6 turn ON. Transistor Q3 couples the Slot V_{I/O} power voltage line 225 to the 3.3V power rail, and transistor Q6 couples the Bridge V_{I/O} power voltage line 210 to the 1.5V power rail. This configuration is suitable for PCI-X mode 1 operation of bus 150.

Although various illustrative embodiments have been described with respect to specific voltages and parameter values, the present invention is not so limited. Other embodiments may use different voltages and different parameter values. Although the various embodiments described above are discrete hardware implementations, a software implementation may be feasible. The software embodiments may comprise a series of computer instructions either fixed on a computer-readable storage medium (e.g. a diskette, a CD-ROM, a ROM, or fixed disk) or transmittable to a modem or other interface device in a computer system via a transmission medium. The transmission medium can be a tangible medium such as optical or analog communications lines, or may be intangible such as a wireless communications network. It may also be the Internet.

It will be apparent to those skilled in the art that many modifications and variations may be made to the embodiments as set forth above without departing substantially from the principles of the present invention. All such modifications and variations are intended to be limited only by the appended claims.

1. A voltage switching method that comprises:
when a mode selection signal is in a first state, providing a first power rail voltage on a first power voltage line and providing a second, different power rail voltage on a second power voltage line; and
after the mode selection signal transitions to a second state, providing the second power rail voltage on the first power voltage line and closing a switch that connects the second power voltage line to the first power voltage line.

2. The method of claim 1, further comprising:
isolating the first and second power voltage lines from the first and second power rail voltages after the mode selection signal transitions to the second state and before providing the second power rail voltage on the first power voltage line and closing the switch.

3. The method of claim 1, wherein the first power voltage line transports power to one or more removable bus devices.

4. The method of claim 3, wherein the second power voltage line transports power to a bus bridge circuit.

5. The method of claim 4, wherein the first power rail voltage is about 3.3 volts, and the second power rail voltage is about 1.5 volts.

6. The method of claim 5, wherein the bus bridge circuit is part of a PCI-X bus bridge.

7. The method of claim 1, wherein the switch comprises a metal-oxide-semiconductor field effect transistor (MOSFET) having a channel connected between the first and second power voltage lines.

8. A switching circuit that comprises:
a first selector circuit coupled to a first power voltage line, wherein the first selector circuit is configured to provide a first power rail voltage on the first power voltage line when a mode selection signal indicates a first mode, and wherein the first selector circuit is configured to provide a second power rail voltage on the first power voltage line after the mode selection signal begins indicating a second mode;
a second selector circuit that comprises:
a switch connected between a second power voltage line and the first power voltage line,
wherein the second selector circuit is configured to provide the second power rail voltage on the second power voltage line when the mode selection signal indicates the first mode, and wherein the second selector circuit is configured to close the switch after the mode selection signal begins indicating the second mode.

9. The circuit of claim 8, wherein the first and second selector circuits are configured to isolate the first and second power voltage lines from the first and second power rail voltages for a small interval after the mode selection signal begins indicating the second mode.

10. The circuit of claim 8, wherein the first power voltage line transports power to one or more removable bus devices.

11. The circuit of claim 10, wherein the second power voltage line transports power to a bus bridge circuit.

12. The circuit of claim 11, wherein the bus bridge circuit is part of a PCI-X bus bridge.

13. The circuit of claim 8, wherein the first power rail voltage is about 3.3 volts, and the second power rail voltage is about 1.5 volts.

14. The circuit of claim 8, wherein the switch comprises a metal-oxide-semiconductor field effect transistor (MOSFET) having a channel connected between the first and second power voltage lines.

15. The circuit of claim 8, further comprising:
a control circuit configured to receive the mode selection signal, and further configured to provide two control signals to each of the first and second selector circuits.

16. The circuit of claim 15, wherein a first of the two control signals is a logical inverse of the mode selection signal, and wherein a second of the two control signals is inverted with respect to the first control signal with a fixed time interval between upward going transitions in the first control signal and downward going transitions in the second control signal.

17. A switching circuit that comprises:
a control circuit that includes:
a first transistor having a gate configured to receive a mode selection signal, a source coupled to ground, and a drain coupled to a first resistor that is coupled to a positive power rail; and
a second transistor having a gate coupled to the drain of the first transistor, a source coupled to ground, and a drain coupled to a second resistor that is coupled to the positive power rail;
a first selector circuit that includes:
a third transistor having a gate coupled to the drain of the second transistor, a source coupled to a first power voltage line, and a drain coupled to a first power voltage rail; and
a fourth transistor having a gate coupled to the drain of the first transistor, a source coupled to the first power voltage line, and a drain coupled to a second power voltage rail; and
a second selector circuit that includes:
a fifth transistor having a gate coupled to the drain of the first transistor, a source coupled to a second power voltage line, and a drain coupled to the first power voltage line; and
a sixth transistor having a gate coupled to the drain of the second transistor, a source coupled to the second power voltage line, and a drain coupled to the second power voltage rail.

18. The switching circuit of claim 17, wherein the control circuit further comprises a capacitor coupled between ground and the drain of the second transistor.

19. A system, comprising:
a PCI bus slot connector configured to receive a removable PCI-X device;
a bus bridge coupled to the PCI bus slot connector by a PCI-X bus having a Slot V_{I/O} power voltage line, wherein the bus bridge includes:
bus control circuitry powered from a Bridge V_{I/O} power voltage line and configured to support communications between the bus bridge and a removable PCI-X device in the slot connector; and
a switching circuit configured to apply one of multiple power rail voltages on the Slot V_{I/O} power voltage line in response to a mode selection signal, wherein the switching circuit includes a selection transistor connected between the Slot V_{I/O} power voltage line and the Bridge V_{I/O} power voltage line, and wherein the switching circuit is configured to turn the selection transistor ON when the mode selection signal indicates PCI-X mode 2.

20. The system of claim 19, wherein the switching circuit comprises:
a control circuit that includes:
a first transistor having a gate configured to receive the mode selection signal, a source coupled to ground, and a drain coupled to a first resistor that is coupled to a positive power rail; and
a second transistor having a gate coupled to the drain of the first transistor, a source coupled to ground, and a drain coupled to a second resistor that is coupled to the positive power rail.

21. The system of claim 20, wherein the switching circuit further comprises:
a first selector circuit that includes:
a third transistor having a gate coupled to the drain of the second transistor, a source coupled to the Slot V_{I/O} power voltage line, and a drain coupled to a first power voltage rail; and
a fourth transistor having a gate coupled to the drain of the first transistor, a source coupled to the Slot V_{I/O} power voltage line, and a drain coupled to a second power voltage rail.

22. The system of claim 21, wherein the switching circuit further comprises:
a second selector circuit that includes:
said selection transistor connected between the Slot V_{I/O} power voltage line and the Bridge V_{I/O} power voltage line, said selection transistor having a gate coupled to the drain of the first transistor; and
a sixth transistor having a gate coupled to the drain of the second transistor, a source coupled to the Bridge V_{I/O} power voltage line, and a drain coupled to the second power voltage rail.

23. The system of claim 20, wherein the control circuit further comprises a capacitor coupled between ground and the drain of the second transistor.
